(19) United States
(12) Patent Application Publication
(10) Pub. No.: US 2024/0294730 A1
(43) Pub. Date: Sep. 5, 2024

(54) SULFUR-CROSSLINKABLE RUBBER MIXTURE, VULCANIZATE OF THE RUBBER MIXTURE, AND VEHICLE TIRE

(71) Applicant: Continental Reifen Deutschland GmbH, Hannover (DE)

(72) Inventors: David-Raphael Dauer, Dassel (DE); Julien Davin, Hessisch Oldendorf (DE); Nils Hojdis, Wuppertal (DE); Norbert Müller, Nienhagen (DE); Carla Recker, Hannover (DE); Fabian Schax, Seelze (DE); Julia Schöffel, Hannover (DE); Gesa Tarantola, Hannover (DE); Christine Weber, Garbsen (DE)

(73) Assignee: Continental Reifen Deutschland GmbH, Hannover (DE)

(21) Appl. No.: 18/564,972

(22) PCT Filed: May 3, 2022
(86) PCT No.: PCT/DE2022/200085

§ 371 Date: Nov. 28, 2023

(30) Foreign Application Priority Data
May 31, 2021 (DE) 10 2021 205 543.5

(51) Int. Cl. C08K 3/06; B60C 1/00; C08K 3/36; C08K 5/548; C08L 9/06

(52) U.S. Cl. CPC C08K 3/06; B60C 1/0016; C08K 3/36; C08K 5/548; C08L 9/06; C08K 2201/014

(57) ABSTRACT

A sulfur-crosslinkable rubber mixture, to the vulcanizate thereof, and to a vehicle tire. The sulfur-crosslinkable rubber mixture comprises at least the following constituents: —at least one solution-polymerized styrene-butadiene rubber (SSBR) having a glass transition temperature T_{g} according to DSC of −35° C. to −85° C.; and —at least one silica; and —1 to 30 phf of at least one silane A having the general empirical formula A-I) (R¹)ₒSi—R²—(S—R³)_{q}—S—X; and —0.5 to 30 phf of at least one silane B having the general empirical formula B-I) (R¹)ₒSi—R²—(S—R³)ᵤ—S—R²—Si(R¹)ₒ, where q=1 or 2 or 3; and u=1 or 2 or 3; and X is a hydrogen atom or a —C(═O)—R⁸ group where R⁸ is selected from hydrogen, C₁-C₂₀ alkyl groups, C₆-C₂₀ aryl groups, C₂-C₂₀ alkenyl groups and C₇-C₂₀ aralkyl groups.

### CROSS-REFERENCE TO RELATED APPLICATIONS

The present application is a National Stage Application under 35 U.S.C. § 371 of International Patent Application No. PCT/DE2022/200085 filed on May 3, 2022, which claims priority from German Patent Application No. 10 2021 205 543.5 filed on May 31, 2021, the disclosures of which are herein incorporated by reference in their entireties.

### TECHNICAL FIELD

The invention relates to a sulfur-crosslinkable rubber mixture, to the vulcanizate thereof, and to a vehicle tire.

### BACKGROUND

To a high degree, the rubber composition of the tread determines the running properties of a vehicle tire, particularly of a pneumatic vehicle tire.

The rubber mixtures which find use particularly in the parts of belts, hoses and cords that are subject to severe mechanical stress are substantially responsible for the stability and long life of these rubber articles. Therefore, very high demands are made on these rubber mixtures for pneumatic vehicle tires, cords, belts and hoses.

There are trade-offs between most of the known tire properties, such as wet grip characteristics, braking characteristics, handling characteristics, rolling resistance, winter properties, abrasion characteristics and friction properties.

Particularly in the case of pneumatic vehicle tires, various attempts have been made to positively influence the properties of the tire through the variation of the polymer components, the fillers and the other admixtures, particularly in the tread mixture.

In this context, it has to be taken into account that any improvement in one tire property often entails a deterioration in another property.

In a given blend system, for example, there exist various known ways of optimizing the handling characteristics by increasing the stiffness of the rubber mixtures. Mention should be made here, for example, of an increase in the filler level and the increase in the node density of the vulcanized rubber mixture. While an increased proportion of filler brings disadvantages in terms of rolling resistance, boosting the network leads to a deterioration in the tear properties and the wet grip indicators of the rubber mixture.

It is also known that rubber mixtures, especially for the tread of pneumatic vehicle tires, may comprise silica as filler. It is additionally known that advantages with regard to the rolling resistance characteristics and processability of the rubber mixture arise when the silica has been bonded to the polymer(s) by means of silane coupling agents.

Silane coupling agents known in the prior art are disclosed, for example, by DE 2536674 C3 and DE 2255577 C3.

It is possible in principle to draw a distinction between silanes that bond solely to silica or comparable fillers and especially have at least one silyl group for the purpose, and silanes that have, in addition to a silyl group, a reactive sulfur moiety such as, in particular, an Sₓ moiety (with x>or equal to 2) or a mercapto group S—H or blocked S-PG moiety where PG represents a protecting group, such that the silane can also bond to polymers in the sulfur vulcanization by reaction of the Sₓ or S—H moiety or the S-PG moiety after removal of the protecting group.

In some cases the prior art additionally discloses combinations of selected silanes.

EP 1085045 B1 discloses a rubber mixture comprising a combination of a polysulfidic silane (mixture comprising 69% to 79% by weight of disulfide fraction, 21 to 31% by weight of trisulfide fraction and 0% to 8% by weight of tetrasulfide fraction) and a silane which has only one sulfur atom and therefore cannot bond to polymers. Such a silane mixture in conjunction with carbon black and silica as filler achieves an optimized profile of properties with regard to the laboratory predictors for, inter alia, rolling resistance and abrasion and optimal tire properties when used in the tread of pneumatic vehicle tires.

WO 2012092062 discloses a combination of a blocked mercaptosilane (NXT) with filler-reinforcing silanes which have non-reactive alkyl groups between the silyl groups.

WO 2019105614 A1 also discloses a rubber mixture comprising a combination of a silane that bonds to polymers and a filler-reinforcing silane.

### SUMMARY

It is an object of the present invention to provide a rubber mixture which, compared to the prior art, exhibits a further improvement in the profile of properties comprising braking characteristics and handling characteristics, in particular through stiffness. At the same time the remaining physical properties of the rubber mixture shall not be adversely impaired or shall even likewise be improved.

This object is achieved by a rubber mixture comprising the following constituents:
at least one solution-polymerized styrene-butadiene rubber (SSBR) having a glass transition temperature T_{g} according to DSC of −35° C. to −85° C.; and
at least one silica; and
1 to 30 phf of at least one silane A having the general empirical formula A-I)

(R¹)ₒSi—R²—(S—R³)_{q}—S—X; and A-I)
0.5 to 30 phf of at least one silane B having the general empirical formula B-I)

B-I) (R¹)oSi-R²-(S-R³)u-S-R²-Si(R¹)ₒ
where the indices o are independently of one another 1, 2 or 3; and the radicals R¹ may be the same or different and are selected from C₁-C₁₀ alkoxy groups,
C₆-C₂₀ phenoxy groups, C₂-C₁₀ cyclic dialkoxy groups,
C₂-C₁₀ dialkoxy groups, C₄-C₁₀ cycloalkoxy groups, C₆-C₂₀ aryl groups,
C₁-C₁₀ alkyl groups, C₂-C₂₀ alkenyl groups, C₂-C₂₀ alkynyl groups,
C₇-C₂₀ aralkyl groups, halides or
alkyl polyether group —O—(R⁶—O)ᵣ—R⁷, where the R⁶ radicals are the same or different and are branched or unbranched, saturated or unsaturated, aliphatic, aromatic or mixed aliphatic/aromatic divalent C₁-C₃₀ hydrocarbon groups, r is an integer from 1 to 30 and the R⁷ radicals are unsubstituted or substituted, branched or unbranched monovalent alkyl, alkenyl, aryl or aralkyl groups, or
two R¹ correspond to a dialkoxy group having 2 to 10 carbon atoms, in which case o is <3,
or two or more silanes of the formulae A-I) and/or B-I) may be bridged via R¹ radicals or by condensation; and
with the condition that in the formulae A-I) and B-I) in each (R¹)ₒSi group there is at least one R¹ selected from those abovementioned options where this R¹ i) is bonded to the silicon atom via an oxygen atom or ii) is a halide; and
where the R² and R³ radicals in each molecule and within a molecule may be the same or different and are branched or unbranched, saturated or unsaturated, aliphatic, aromatic or mixed aliphatic/aromatic divalent C₁-C₃₀ hydrocarbon groups; and where q is 1 or 2 or 3; and u is 1 or 2 or 3; and X is a hydrogen atom or a —C(═O)—R⁸ group where R⁸ is selected from hydrogen, C₁-C₂₀ alkyl groups, C₆-C₂₀ aryl groups, C₂-C₂₀ alkenyl groups and C₇-C₂₀ aralkyl groups.

It has surprisingly been found that the combination of the silanes A and B and at least one SSBR having a T_{g} of −35 (minus thirty-five) to −85 (minus eighty-five) ° C. (degrees Celsius) and a silica achieves an improvement in the profile of properties comprising handling properties and braking characteristics.

The invention comprises all advantageous embodiments which are reflected inter alia in the claims. The invention especially also comprises embodiments which result from a combination of different features, for example of constituents of the rubber mixture, with different levels of preference for these features so that the invention also comprises a combination of a first feature described as “preferred” or described in the context of an advantageous embodiment with a further feature described for example as “particularly preferred”.

The present invention further provides a vulcanizate of at least one rubber mixture of the invention.

The present invention further provides a vehicle tire which comprises at least one inventive vulcanizate of the inventive rubber mixture in at least one component. It is preferable when the vehicle tire has at least one vulcanizate according to the invention at least in the tread.

The vulcanizate according to the invention and the vehicle tire according to the invention are characterized by an optimized profile of properties from the above-mentioned properties.

In the case of two-part treads (upper part: cap and lower part: base), the rubber mixture according to be the invention may used both for the cap and for the base. Preferably, at least the cap or at least the base, or at least the cap and the base, include(s) at least one inventive vulcanizate of the inventive rubber mixture.

Within the context of the present invention, “vehicle tires” are understood to mean pneumatic vehicle tires and solid rubber tires, including tires for industrial and construction site vehicles, truck, car and two-wheeled-vehicle tires.

Moreover, the rubber mixture of the invention is also suitable for other components of vehicle tires, for example the flange profile in particular, and also for inner tire components. Moreover, the rubber mixture of the invention is also suitable for other industrial rubber articles, such as bellows, conveyor belts, air springs, belts, drive belts or hoses, and also footwear soles.

There follows a detailed description of the constituents of the sulfur-crosslinkable rubber mixture of the invention. All of the observations are equally valid for the vulcanizate of the invention and for the vehicle tire of the invention, comprising at least one inventive vulcanizate of the inventive rubber mixture in at least one component.

The unit “phr” (parts per hundred parts of rubber by weight) used in this document is the standard unit of quantity for mixture recipes in the rubber industry. In this document, the dosage of the individual substituents is based on 100 parts by weight of the total mass of all rubbers present in the mixture that have a molecular weight M_{w} by GPC of greater than 20 000 g/mol.

The unit “phf” (parts per hundred parts of filler by weight) used in this document is the standard unit of quantity for coupling agents for fillers in the rubber industry.

In the context of the present application, phf relates to the silica present, meaning that any other fillers present, such as carbon black, are not included in the calculation of the amount of silane.

According to the invention the rubber mixture comprises at least one solution-polymerized styrene-butadiene rubber (SSBR) which has a glass transition temperature T_{g} according to DSC (differential scanning calorimetry, according to ISO22768; calibrated DSC with low temperature apparatus (nitrogen cooling); calibration with zinc;
cooling rate 20° C./min to −140° C. (hold at this temperature for 5 min); heating rate 10° C./min to +70° C.; aluminum crucible) from −35° C. (minus thirty-five degrees celsius) to −85° C. (minus eighty-five degrees celsius).

The solution-polymerized styrene-butadiene rubber (SSBR) preferably has a glass transition temperature T_{g} according to DSC of −40 to −65° C. This achieves the object of the invention particularly well, resulting in a particularly optimized profile of properties of the vulcanized rubber mixture.

In advantageous embodiments the rubber mixture according to the invention comprises a solution-polymerized styrene-butadiene rubber (SSBR) having a glass transition temperature T_{g} according to DSC of −35 to −85° C., preferably −40 to −65° C., in amounts of 50 to 100 phr, preferably 75 to 100 phr, particularly preferably 85 to 100 phr. These specified amounts also apply in the event that two or more SSBR having a glass transition temperature T_{g} according to DSC of −35 to −85° C., preferably −40 to −65° C., are present, in that case as total amounts of these SSBR.

The SSBR(s) employed may be end group-modified and/or modified along the polymer chains with functionalizations. The terms “functionalization” and “modification” are used synonymously.

The modification may be selected from modifications with hydroxyl groups and/or ethoxy groups and/or epoxy groups and/or siloxane groups and/or amino groups and/or aminosiloxane and/or carboxyl groups and/or phthalocyanine groups and/or silane-sulfide groups.

However, other functionalizations known to those skilled in the art are also suitable. Metal atoms may be a constituent of such functionalizations.

In particular, the SSBR(s) having a T_{g} of 35 to −85° C., preferably −40 to −65° C., may be functionalized with representatives of the recited groups which allow bonding of silica filler to the rubber mixture.

It will be clear to the person skilled in the art that no further rubber is present when the amount is 100 phr.

At an amount of less than 100 phr of the SSBR at least one further diene rubber is preferably present.

The rubber mixture preferably comprises at least one further diene rubber having a molecular weight M_{w} according to GPC of greater than 20 000 g/mol, which is selected from the group consisting of natural polyisoprene (NR), synthetic polyisoprene (IR), butadiene rubber (BR), solution-polymerized styrene-butadiene rubber (SSBR) having a glass transition temperature T_{g} according to DSC above −35° C. or below −85° C. and emulsion-polymerized styrene-butadiene rubber (ESBR).

It is particularly preferable when the further diene rubber is selected from the group consisting of natural polyisoprene (NR), synthetic polyisoprene (IR), butadiene rubber (BR). Such a rubber mixture is particularly suitable for the tread of vehicle tires.

In particularly advantageous embodiments, natural polyisoprene (NR) is present as a further diene rubber. This achieves a particularly good processability of the rubber mixture according to the invention.

The natural and/or synthetic polyisoprene of all embodiments may be either cis-1,4-polyisoprene or 3,4-polyisoprene. However, the use of cis-1,4-polyisoprenes having a cis-1,4 proportion of >90% by weight is preferred. Such a polyisoprene is firstly obtainable by stereospecific polymerization in solution with Ziegler-Natta catalysts or using finely divided lithium alkyls. Secondly, natural rubber (NR) is a cis-1,4-polyisoprene for which the cis-1,4 content in the natural rubber is greater than 99% by weight.

A mixture of one or more natural polyisoprenes with one or more synthetic polyisoprenes is further also conceivable.

In the context of the present invention the term “natural rubber” is to be understood as meaning naturally occurring rubber which may be obtained from Hevea rubber trees and from “non-Hevea” sources. Non-Hevea sources include for example guayule shrubs and dandelion such as for example TKS (Taraxacum kok-saghyz; Russian dandelion).

The further diene rubber is preferably present in amounts of 1 to 50 phr, particularly preferably 1 to 25 phr, very particularly preferably 1 to 15 phr.

The amount of SSBR having a glass transition temperature T_{g} according to DSC of −35 to −85° C., preferably −40 to −65° C., is then 50 to 99 phr, particularly preferably 75 to 99 phr, very particularly preferably 85 to 99 phr, and so the total amount of diene rubbers present having a molecular weight M_{w} according to GPC of greater than 20 000 g/mol is 100 phr.

According to the invention, the rubber mixture comprises at least one silica.

The silica may be any of the types of silica known to those skilled in the art that are suitable as filler for tire rubber mixtures. However, particular preference is given to using a finely divided, precipitated silica which has a nitrogen surface area (BET surface area) (in accordance with DIN ISO 9277 and DIN 66132) of 35 to 400 m²/g, preferably 35 to 350 m²/g, more preferably 85 to 320 m²/g and most preferably 120 to 235 m²/g, and a CTAB surface area (in accordance with ASTM D 3765) of 30 to 400 m²/g, preferably 30 to 330 m²/g, more preferably 80 to 300 m²/g and most preferably 110 to 230 m²/g. Such silicas lead, for example in rubber mixtures for tire treads, to particularly good physical properties of the vulcanizates. Advantages in mixture processing by way of a reduction in mixing time can also arise here while retaining the same product properties, leading to improved productivity. Silicas used may thus, for example, be either those of the Ultrasil® VN3 type (trade name) from Evonik or highly dispersible silicas known as HD silicas (e.g. Zeosil® 1165 MP from Solvay).

In a preferred embodiment of the invention the rubber mixture according to the invention comprises 20 to 300 phr, preferably 20 to 250 phr, particularly preferably 40 to 150 phr and very particularly preferably 70 to 100 phr of at least one silica.

Where at least two different silicas, differing, for example, in their BET surface area, are present in the rubber mixture of the invention, the quantity figures stated always refer to the total amount of all silicas present.

The terms “silicic acid” and “silica” are used synonymously in the context of the present invention.

The rubber mixture of the invention may also comprise at least one carbon black, especially an industrial carbon black.

Suitable carbon blacks include any carbon black types familiar to the skilled person.

In an advantageous embodiment of the invention the rubber mixture comprises 0 phr of carbon blacks.

In a further advantageous embodiment of the invention the rubber mixture comprises 0.1 to 20 phr, in particular 0.1 to 10 phr, of carbon blacks.

The rubber mixture according to the invention may comprise preferably the smallest possible amounts, i.e preferably 0 to 20 phr, particularly preferably 0 to 10 phr, of further fillers. Within the context of the present invention, the further (non-reinforcing) fillers include aluminosilicates, kaolin, chalk, starch, magnesium oxide, titanium dioxide, or rubber gels and also fibers (for example aramid fibers, glass fibers, carbon fibers, cellulose fibers).

Further, optionally reinforcing fillers are for example carbon nanotubes ((CNTs), including discrete CNTs, hollow carbon fibers (HCF) and modified CNTs comprising one or more functional groups such as hydroxy, carboxy and carbonyl groups), graphite and graphene and what is known as “carbon-silica dual-phase filler”.

In the context of the present invention zinc oxide is not included among the fillers.

According to the invention the rubber mixture comprises 1 to 30 phf, preferably 2 to 20 phf, particularly preferably 2 to 10 phf, of at least one silane A having the general empirical formula A-I)

A-I)ₒSi-R²-(S-R³)_{q}-S-X;
and 0.5 to 30 phf, preferably 0.5 to 20 phf, particularly preferably 1 to 10 phf, of at least one silane B of general empirical formula B-I)

B-I)ₒ(R¹)ₒSi-R²(S-R³)ᵤ-S-R²-Si(R¹)ₒ,
where the above-mentioned definitions and elucidations apply.

The silane A present according to the invention is a silane as a result of the S—X moiety and can bond to polymers by eliminating X, i.e. the hydrogen atom or the —C(═O)—R⁸ group.

It is also possible for various silanes having various X groups to be present.

X is a hydrogen atom or a —C(═O)—R⁸ group, where R⁸ is selected from hydrogen, C₁-C₂₀ akyl groups, preferably C₁-C₁₇, C₆-C₂₀ aryl groups, preferably phenyl, C₂-C₂₀ alkenyl groups and C₇-C₂₀ aralkyl groups.

It is preferable when X is a —C(═O)—R⁸ group, where R⁸ is more preferably a C₁-C₂₀ alkyl group and X is thus an alkanoyl group.

In an advantageous embodiment, the alkanoyl group has a total of 1 to 3 and especially 2 carbon atoms.

In a further advantageous embodiment, the alkanoyl group has a total of 7 to 9 and especially 8 carbon atoms.

The index q may assume the values 1 or 2 or 3. q is preferably 1.

The silane B present according to the invention comprises individual sulfur atoms which cannot bond to the polymer chains of the diene rubber since the chemical bond —C—S—C— is typically not broken during the vulcanization.

The index u may assume the values 1 or 2 or 3. u is preferably 1.

It is preferable when R² is an alkyl group having 2 or 3 carbon atoms, preferably
—CH₂CH₂— or —CH₂CH₂CH₂—, particularly preferably —CH₂CH₂CH₂—.

It is preferable when R³ is an alkyl group having 4 to 8 carbon atoms and is preferably selected from —CH₂CH₂CH₂CH₂CH₂—, —CH₂CH₂CH₂CH₂CH₂CH₂—, —CH₂CH₂CH₂CH₂CH₂CH₂CH₂— and —CH₂CH₂CH₂CH₂CH₂CH₂CH₂CH₂—, particularly preferably —CH₂CH₂CH₂CH₂CH₂CH₂—.

All these R¹ radicals and bridges from one or more silanes via R¹ radicals may be combined with one another within a silyl group.

If two R¹ correspond to a dialkoxy group having 2 to 10 carbon atoms and then o<3 (o is less than 3), the silicon atom is part of a ring system.

If two silanes of formula A-I) and/or B-I) are bridged to one another, they share an R¹ radical or are joined to one another via an oxygen atom by combination of two Si—R¹— groups. It is also possible for more than two silanes to be joined to one another in this way. Following the synthesis of the silane of formula A-I) and/or B-I) it is thus conceivable for two silanes of formula A-I) and/or B-I) to be bridged to one other via an oxygen atom or via the R¹ radicals. It is also possible for more than two silanes to be joined to one another in this way, for example via dialkoxy groups.

The rubber mixture of the invention may thus also comprise oligomers that form through hydrolysis and condensation or through bridging by means of dialkoxy groups as R¹ of the silanes A and/or silanes B (silanes of formula A-I) and/or B-I)).

The silanes of the formulae A-I) and B-I) in each case comprise at least one R¹ radical that can serve as leaving group by virtue of the condition that, in the formulae A-I) and B-I), in each (R¹)ₒSi— group there is at least one R¹ selected from those abovementioned options where this R¹ i) is bonded to the silicon atom via an oxygen atom or ii) is a halide.

These are thus especially alkoxy groups, phenoxy groups or all other groups mentioned that are bonded to the silicon atom by an oxygen atom, or halides.

The radicals R¹ preferably comprise alkyl groups having 1 to 6 carbon atoms or alkoxy groups having 1 to 6 carbon atoms, or halides, particularly preferably alkoxy groups having 1 to 6 carbon atoms.

In a particularly advantageous embodiment of the invention, the R¹ radicals within a silyl group (R¹)ₒSi— are the same and are alkoxy groups having 1 or 2 carbon atoms, i.e. methoxy groups or ethoxy groups, most preferably ethoxy groups, where o is 3.

But even in the case of oligomers or if two R¹ form a dialkoxy group, the remaining R¹ radicals are preferably alkyl groups having 1 to 6 carbon atoms or halides or alkoxy groups having 1 to 6 carbon atoms, preferably 1 or 2 carbon atoms, i.e. methoxy groups or ethoxy groups, most preferably ethoxy groups.

In the context of the present invention, ethoxy groups in the formulae of the silanes are abbreviated to EtO or OEt. The two syntaxes illustrate that alkoxy groups such as ethoxy groups are bonded to the silicon atom Si via the oxygen atom O.

In principle, however, the abbreviations OEt and EtO can be used synonymously in the context of the present invention.

In a preferred embodiment of the invention the silane A has the following structure according to formula A-II):

A-II) (EtO)₃Si-(CH₂)₃-S-(CH₂)₆-S-C(=O)-CH₃.

In a preferred embodiment of the invention the silane A has the following structure according to formula A-III):

(EtO)₃Si—(CH₂)₃—S—(CH₂)₆—S—C(═O)—(CH₂)₆—CH₃. A-III)

It is also conceivable for the rubber mixture according to the invention to comprise a mixture of two or more of the silanes A-II) and A-III).

It is also conceivable for the rubber mixture according to the invention to comprise a mixture of the silanes A-II) and/or A-III) with at least one further silane of the parent formula A-I).

The total amount of silanes A present that conform to formula A-I) is in each case 1 to 30 phf, preferably 2 to 20 phf, particularly preferably 2 to 10 phf.

In a preferred embodiment of the invention the silane B has the following structure according to formula B-II):

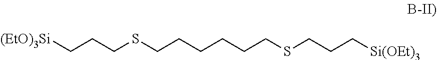

i.e. (EtO)₃Si—(CH₂)₃—S—(CH₂)₆—S—(CH₂)₃—Si(OEt)₃.

Particularly optimized handling and braking predictors are achieved with a silane according to formula B-II).

It is also conceivable for the rubber mixture according to the invention to comprise a mixture of two silanes of formula B-I), for example B-II) with a further silane of formula B-I).

The total amount of silanes B present that conform to formula B-I) is in each case 0.5 to 30 phf, preferably 0.5 to 20 phf, particularly preferably 0.5 to 10 phf.

Especially the preferred and particularly preferred amounts and embodiments of the silanes A and B result in very good properties in terms of handling and braking predictors.

It is particularly preferable when the molar ratio of silanes A present to silanes B present is 20:80 to 90:10, preferably 55:45 to 70:30.

The rubber mixture can further comprise customary additives in customary parts by weight which are added preferably in at least one primary mixing stage during the production of said mixture. These additives include
a) aging stabilizers such as for example diamines, such as N-phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-(1,4-dimethylpentyl)-N′-phenyl-p-phenylenediamine (7PPD), N-isopropyl-N′-phenyl-p-phenylenediamine (IPPD), or dihydroquinolines, such as 2,2,4-trimethyl-1,2-dihydroquinoline (TMQ),
b) activators, for example zinc oxide and fatty acids (e.g. stearic acid) and/or other activators, such as zinc complexes, for example zinc ethylhexanoate,
c) activators and/or agents for binding fillers, in particular carbon black, for example S-(3-aminopropyl)thiosulfuric acid and/or metal salts thereof (binding to carbon black),
d) antiozonant waxes,
e) resins, especially tackifying resins for internal tire components,
f) masticating aids, for example 2,2′-dibenzamidodiphenyl disulfide (DBD), and
g) processing aids, such as in particular fatty acid esters and metal soaps, for example zinc soaps and/or calcium soaps,
h) plasticizers, such as in particular aromatic, naphthenic or paraffinic mineral oil plasticizers, for example MES (mild extraction solvate) or RAE (residual aromatic extract) or TDAE (treated distillate aromatic extract), or rubber-to-liquid oils (RTL) or biomass-to-liquid oils (BTL) preferably having a content of polycyclic aromatics of less than 3% by weight according to method IP 346 or triglycerides, for example rapeseed oil or factices or hydrocarbon resins.

When using mineral oil this is preferably selected from the group consisting of DAE (distillate aromatic extracts), RAE (residual aromatic extract), TDAE (treated distillate aromatic extracts), MES (mild extracted solvents) and naphthenic oils.

The total proportion of further additives is preferably 3 to 150 phr, more preferably 3 to 100 phr and most preferably 5 to 80 phr.

Zinc oxide (ZnO) may be included in the overall proportion of the further additives. This may be any type of zinc oxide known to those skilled in the art, for example ZnO granules or powder. The zinc oxide conventionally used generally has a BET surface area of less than 10 m²/g. However, it is also possible to use a zinc oxide having a BET surface area of 10 to 100 m²/g, for example so-called “nano zinc oxides”.

The inventive rubber mixture is preferably employed in vulcanized form, in particular in vehicle tires or other vulcanized technical rubber articles.

The terms “vulcanized” and “crosslinked” are used synonymously in the context of the present invention.

The vulcanization of the rubber mixture of the invention is preferably conducted in the presence of sulfur and/or sulfur donors with the aid of vulcanization accelerators, it being possible for some vulcanization accelerators to act simultaneously as sulfur donors. The accelerator is selected from the group consisting of thiazole accelerators, mercapto accelerators, sulfenamide accelerators, thiocarbamate accelerators, thiuram accelerators, thiophosphate accelerators, thiourea accelerators, xanthogenate accelerators and guanidine accelerators.

It is preferable to use a sulfenamide accelerator selected from the group consisting of N-cyclohexyl-2-benzothiazolesulfenamide (CBS), N,N-dicyclohexylbenzothiazole-2-sulfenamide (DCBS), benzothiazyl-2-sulfenomorpholide (MBS), N-tert-butyl-2-benzothiazylsulfenamide (TBBS) and guanidine accelerators such as diphenylguanidine (DPG).

The sulfur donor substances used may be any sulfur donor substances known to those skilled in the art.

Vulcanization retarders may also be present in the rubber mixture.

Production of the rubber mixture is otherwise carried out by the processes customary in the rubber industry comprising initially producing in one or more mixing stages a primary mixture comprising all constituents except the vulcanization system (for example sulfur and vulcanization-influencing substances). The finished mixture is produced by adding the vulcanization system in a final mixing stage.

The finished mixture is for example processed further and brought into the appropriate shape by means of an extrusion operation or calendering.

The rubber mixture according to the invention is particularly suitable for use in vehicle tires, especially pneumatic vehicle tires. Employment is conceivable in principle here in all tire components, especially in a tread, more particularly in the cap of a tread with cap/base construction, as already described above.

For use in vehicle tires, the mixture, as a finished mixture prior to vulcanization, is preferably brought into the shape of a tread and is applied in the known manner during production of the green vehicle tire.

The rubber mixture of the invention is produced as already described for use as a sidewall or other body mixture in vehicle tires. The difference lies in the shaping after the extrusion operation/the calendering of the mixture. The shapes thus obtained of the as-yet unvulcanized rubber mixture for one or more different body mixtures then serve for the construction of a green tire.

“Body mixture” refers here to the rubber mixtures for the other components of a tire, such as essentially separating plate, inner liner (inner layer), core profile, breaker belt, shoulder, breaker belt profile, carcass, bead reinforcement, bead profile, flange profile and bandage. For use of the rubber mixture of the invention in drive belts and other belts, especially in conveyor belts, the extruded, as-yet unvulcanized mixture is brought into the appropriate shape and often provided at the same time or subsequently with strength members, for example synthetic fibers or steel cords.

Subsequently, further processing is carried out by vulcanization.

The invention shall now be more particularly elucidated with reference to comparative and working examples summarized in the tables which follow.

The general composition is specified in Table 1, while the properties of the different mixtures after variation of the silane and the SSBR are reported in Tables 2 to 4.

The inventive rubber mixtures are identified with “E” and comparative mixtures with “V”.

TABLE 1

| Constituents | Unit | Amount |
|---|---|---|
| NR | phr | 10 |
| SSBR var. ^{g) to n)} | phr | 90 |
| Silica ^{a)} | phr | 95 |
| Plasticizer oil | phr | 35 |
| Silane ^{b)} | phf | var. |
| Silane ^{c)} | phf | var. |
| Silane ^{d)} | phf | var. |
| Other additives ^{e)} | phr | 9 |
| Accelerator ^{f)} | phr | 4 |
| Sulfur | phr | 2 |

The reported amounts of the silanes in phf (in Tables 2 to 4) are based on 95 phr of silica.

Equimolar exchange of the silane took place, thus resulting in different amounts in phf.

### Substances Used

a) Silica: ULTRASIL® VN 3 GR, Evonik Industries
b) NXT, Momentive; comprises >90% by weight of the silane A*) (EtO)₃Si—(CH₂)₃—S—C(═O)—(CH₂)₆—CH₃: bonding but not inventive under formula A-I)
c) Silane of formula A-II) and silane of formula B-II), molar ratio A-II) to B-II)=60:40; the silanes were prepared as described below.
d) Silane 1,8-bis(triethoxysilyl)octane, SIB1824.0, Gelest Inc., non-polymer-bonding but not inventive under formula B-I)
e) Other additives: 2 phr 6PPD, 2 phr antiozonant wax, 2.5 phr zinc oxide, 2.5 phr stearic acid
f) 2 phr DPG, 2 phr CBS
g) SSBR NIPOL® NS210, Zeon Corporation, T_{g}=−42.6° C.
h) SSBR NIPOL® NS612, Zeon Corporation, T_{g}=−58.4° C.
i) SSBR Sprintan® SLR-3402, Trinseo, T_{g}=−58.9° C.
j) SSBR F1038, LG Chem, T_{g}=−55° C.; 4.54 phr of oil present in above amount (thus only 30.46 phr of oil were additionally added instead of 35 phr)
k) SSBR M1038, LG Chem, T_{g}=−60° C.; 4.54 phr of oil present in above amount (thus only 30.46 phr of oil were additionally added instead of 35 phr)
l) SSBR Asaprene™ XB120, Asahi Kasei Cooperation, T_{g}=−62° C.
m) SSBR HPR840, JSR Corporation, T_{g}=−60.6° C.
n) SSBR HPR940, JSR Corporation, T_{g}=−58° C.

The silane according to formula A-II) was produced as follows:
Na₂CO₃ (59.78 g; 0.564 mol) and an aqueous solution of NaSH (40% in water; 79.04 g; 0.564 mol) were initially charged with water (97.52 g). Tetrabutylphosphonium bromide (TBPB) (50% in water; 3.190 g; 0.005 mol) was then added and acetyl chloride (40.58 g; 0.517 mol) was added dropwise over 1 h, the reaction temperature being kept at 25-32° C. After complete addition of the acetyl chloride the mixture was stirred for 1 h at room temperature. Then TBPB (50% in water; 3.190 g; 0.005 mol) and 1-chloro-6-thiopropyltriethoxysilylhexane (see above; 167.8 g; 0.470 mol) were added and the mixture was heated at reflux for 3-5 h. The progress of the reaction was monitored by gas chromatography. Once >96% of the 1-chloro-6-thiopropyltriethoxysilylhexane had reacted, water was added until all salts had dissolved and the phases were separated. The volatile constituents of the organic phase were removed under reduced pressure and

S-(6-((3-(triethoxysilyl)propyl)thio)hexyl) thioacetate)
(yield: 90%, molar ratio: 97% S-(6-((3-(triethoxysilyl)propyl)thio)hexyl) thioacetate (silane A-II), 3% bis(thiopropyltriethoxysilyl)hexane (silane B-II);
% by weight: 96% by weight S-(6-((3-(triethoxysilyl)propyl)thio)hexyl) thioacetate (silane A-II), 4% by weight 1,6-bis(thiopropyltriethoxysilyl)hexane (silane B-II)) as yellow to brown liquid.

The silane of formula B-II): 1,6-bis(thiopropyltriethoxysilyl)hexane was prepared as follows:
Sodium ethoxide (21% in EtOH; 82.3 g; 0.254 mol; 2.05 eq) is metered into mercaptopropyltriethoxysilane (62.0 g; 0.260 mol; 2.10 eq) at such a rate that the reaction temperature does not exceed 35° C. After complete addition the mixture is heated at reflux for 2 h. The reaction mixture is then added to 1,6-dichlorohexane (19.2 g; 0.124 mol; 1.00 eq) over the course of 1.5 h at 80° C. After complete addition the mixture is heated at reflux for 3 h and then allowed to cool to room temperature. Precipitated salts are filtered off and the product is freed of the solvent under reduced pressure. The product (yield: 88%, purity: >99% in ¹³C NMR) was obtained as a clear liquid.

NMR method: The molar ratios and mass fractions specified in the examples as analytical results are derived from ¹³C NMR measurements with the following parameters: 100.6 MHz, 1000 scans, CDCl₃ solvent, internal standard for calibration: tetramethylsilane, relaxation aid Cr(acac)₃, to determine the mass fraction in the product a defined amount of dimethyl sulfone was added as internal standard and the molar ratios of the products thereto were used to calculate the mass fraction.

The prepared silanes A-II) and B-II) were mixed together to obtain the above mentioned molar ratio of 60:40.

The mixtures were produced by the method customary in the rubber industry under standard conditions in three stages in a laboratory mixer with a volume of 300 milliliters to 3 liters, in which, in the first mixing stage (base-mixing stage), all constituents apart from the vulcanization system (sulfur and vulcanization-influencing substances) were first mixed at 145 to 165° C., with target temperatures of 152 to 157° C., for 200 to 600 seconds. In the second stage the mixture from stage 1 was mixed again, performing a so-called remill. Addition of the vulcanization system in the third stage (final mixing stage) afforded the final mixture, by mixing at 90° C. to 120° C. for 180 to 300 seconds.

All of the mixtures were used to prepare test specimens by vulcanization after t95 to t100 (measured on a moving die rheometer according to ASTM D 5289-12/ISO 6502) under pressure at 160° C. to 170° C. and these test specimens were used to determine material properties typical for the rubber industry by the test methods specified hereinbelow.
Shore hardness at room temperature (RT) and 70° C. according to ISO 868, DIN 53 505
Rebound resilience at room temperature (RT) according to ISO 4662 or ASTM D 1054
Stress value at 300% elongation at room temperature (M300 RT) according to DIN 53 504
Dynamic storage modulus E′ at 55° C. from dynamic-mechanical measurement according to DIN 53 513, strain sweep: at 8% elongation (E′(8%)) and mean E′ (mean)
Loss factor tan d, synonymous with tan b, at 0° C. from dynamic-mechanical measurement according to DIN 53513, temperature sweep; 50/30 N: static starting force 30 N, dynamic oscillation between 30 and 50 N

As is apparent from tables 2 to 4 the inventive rubber mixtures comprising the combination of silanes A and B achieve higher stiffnesses (Shore A hardnesses, (E′(8%), E′ (mean), M300) and better braking characteristic indicators (lower values for rebound elasticity at RT and higher values for tan delta at 0° C.) compared to rubber mixtures comprising NXT silane (polymer-bonding but not inventive) or a mixture of NXT silane with a non-polymer bonding silane (1,8-bis(triethoxysilyl)octane).

A vehicle tire comprising the rubber mixture according to the invention in at least one component, preferably at least in the tread, is thus at a higher level in the trade-off between handling characteristics and braking characteristics.

TABLE 2

| | Unit | V1 | E1 | V2 | V3 | E2 | V4 | V5 | E3 | V6 |
|---|---|---|---|---|---|---|---|---|---|---|
| Constituents | | | | | | | | | | |
| SSBR ^{g)} | phr | 90 | 90 | 90 | — | — | — | — | — | — |
| SSBR ^{h)} | phr | — | — | — | 90 | 90 | 90 | — | — | — |
| SSBR ⁱ⁾ | phr | — | — | — | — | — | — | 90 | 90 | 90 |
| Silane ^{b)} | phf | 10.2 | — | 6.4 | 10.2 | — | 6.4 | 10.2 | — | 6.4 |
| Silane ^{c)} | phf | — | 11.1 | — | — | 11.1 | — | — | 11.1 | — |
| Silane ^{d)} | phf | — | — | 4.7 | — | — | 4.7 | — | — | 4.7 |
| Properties | | | | | | | | | | |
| Shore hardness | Shore | 68.4 | 74.5 | 68.9 | 61.9 | 67.7 | 64.7 | 61.6 | 68.4 | 63.7 |
| RT | A | | | | | | | | | |
| Shore hardness | Shore | 64.3 | 70.5 | 65.1 | 59.5 | 64.9 | 62.5 | 59.7 | 66.2 | 61.8 |
| 70° C. | A | | | | | | | | | |
| Rebound | % | 32.7 | 31 | 31.9 | 47.2 | 43.2 | 46.3 | 49.4 | 45.3 | 48.1 |
| resilience RT | | | | | | | | | | |
| M300 RT | MPa | 8.6 | 9.8 | 8.2 | 9 | 9.7 | 9.6 | 9.4 | 10.9 | 9.7 |
| E′(8%) | MPa | 6.7 | 7.2 | 6.4 | 5.7 | 6.3 | 5.9 | 5.6 | 6.4 | 5.9 |
| tan d (0° C.) | | 0.367 | 0.393 | 0.38 | 0.237 | 0.272 | 0.249 | 0.226 | 0.273 | 0.244 |
| 50/30 N | | | | | | | | | | |

TABLE 3

| | Unit | V7 | E4 | V8 | V9 | E5 | V10 | V11 | E6 | V12 |
|---|---|---|---|---|---|---|---|---|---|---|
| Constituents | | | | | | | | | | |
| SSBR ^{j)} | phr | — | — | — | 90 | 90 | 90 | — | — | — |
| SSBR ^{k)} | phr | 90 | 90 | 90 | — | — | — | — | — | — |
| SSBR ^{l)} | phr | — | — | — | — | — | — | 90 | 90 | 90 |
| Silane ^{b)} | phf | 10.2 | — | 6.4 | 10.2 | — | 6.4 | 10.2 | — | 6.4 |
| Silane ^{c)} | phf | — | 11.1 | — | — | 11.1 | — | — | 11.1 | — |
| Silane ^{d)} | phf | — | — | 4.7 | — | — | 4.7 | — | — | 4.7 |
| Properties | | | | | | | | | | |
| Shore | Shore | 66.2 | 68.4 | 66.5 | 62.5 | 65.1 | 63.8 | 65.7 | 70.6 | 67 |
| hardness RT | A | | | | | | | | | |
| Shore | Shore | 63 | 65.7 | 63.9 | 60.5 | 63.2 | 62.4 | 62.2 | 67.3 | 64.5 |
| hardness 70° C. | A | | | | | | | | | |
| Rebound | % | 56.2 | 54.6 | 55.5 | 50.6 | 48.3 | 49.7 | 54 | 48.4 | 52 |
| resilience RT | | | | | | | | | | |
| E′(8%) | MPa | 6.5 | 7.2 | 6.6 | 5.8 | 6.2 | 6 | 6.5 | 7.4 | 6.7 |
| tan d (0° C.) | | 0.176 | 0.189 | 0.182 | 0.211 | 0.233 | 0.222 | 0.191 | 0.237 | 0.204 |
| 50/30 N | | | | | | | | | | |

TABLE 4

| | Unit | V13 | E7 | V14 | V15 | E8 | V16 |
|---|---|---|---|---|---|---|---|
| Constituents | | | | | | | |
| SSBR ^{m)} | phr | 90 | 90 | 90 | — | — | — |
| SSBR ⁿ⁾ | phr | — | — | — | 90 | 90 | 90 |
| Silane ^{b)} | phf | 10.2 | — | 6.4 | 10.2 | — | 6.4 |
| Silane ^{c)} | phf | — | 11.1 | — | — | 11.1 | — |
| Silane ^{d)} | phf | — | — | 4.7 | — | — | 4.7 |
| Properties | | | | | | | |
| Shore hardness | Shore | 63.8 | 67.6 | 63.5 | 61.8 | 65 | 64.6 |
| RT | A | | | | | | |
| Shore hardness | Shore | 59.7 | 64 | 60.4 | 58.8 | 62.6 | 62.3 |
| 70° C. | A | | | | | | |
| Rebound | % | 51.1 | 47.3 | 50.2 | 49.9 | 48 | 48.6 |
| resilience RT | | | | | | | |
| M300 RT | MPa | 11.5 | 13.7 | 12.2 | 11.7 | 13.7 | 13.4 |
| E′ (mean) | MPa | 7.7 | 9 | 7.5 | 7.1 | 8.3 | 8.2 |
| E′(8%) | MPa | 6.2 | 6.8 | 6 | 5.8 | 6.4 | 6.4 |
| tan d (0° C.) | | 0.208 | 0.242 | 0.221 | 0.205 | 0.236 | 0.225 |
| 50/30 N | | | | | | | |

1. A sulfur-crosslinkable rubber mixture comprising at least the following constituents:
at least one solution-polymerized styrene-butadiene rubber (SSBR) having a glass transition temperature T_{g} according to DSC of −35° C. to −85° C.; and
at least one silica; and
1 to 30 phf of at least one silane A having the general empirical formula A-I)
(R¹)ₒSi—R²—(S—R³)_{q}—S—X; and A-I)
0.5 to 30 phf of at least one silane B having the general empirical formula B-I)
BI) (R¹)ₒSi-R²-(S-R³)₋S-R²-Si(R¹)ₒ
where the indices o are independently of one another 1, 2 or 3 and the radicals R¹ may be the same or different and are selected from C₁-C₁₀ alkoxy groups,
C₆-C₂₀ phenoxy groups, C₂-C₁₀ cyclic dialkoxy groups,
C₂-C₁₀ dialkoxy groups, C₄-C₁₀ cycloalkoxy groups, C₆-C₂₀ aryl groups,
C₁-C₁₀ alkyl groups, C₂-C₂₀ alkenyl groups, C₂-C₂₀ alkynyl groups,
C₇-C₂₀ aralkyl groups, halides or
alkyl polyether group —O—(R⁶—O)ᵣ—R⁷, where the R⁶ radicals are the same or different and are branched or unbranched, saturated or unsaturated, aliphatic, aromatic or mixed aliphatic/aromatic divalent C₁-C₃₀ hydrocarbon groups, r is an integer from 1 to 30 and the R⁷ radicals are unsubstituted or substituted, branched or unbranched monovalent alkyl, alkenyl, aryl or aralkyl groups, or
two R¹ correspond to a dialkoxy group having 2 to 10 carbon atoms, in which case o is <3,
or two or more silanes of the formulae A-I) and/or B-I) may be bridged via R¹ radicals or by condensation; and
with the condition that in the formulae A-I) and B-I) in each (R¹)ₒSi group there is at least one R¹ selected from those abovementioned options where this R¹ i) is bonded to the silicon atom via an oxygen atom or ii) is a halide; and
where the R² and R³ radicals in each molecule and within a molecule may be the same or different and are branched or unbranched, saturated or unsaturated, aliphatic, aromatic or mixed aliphatic/aromatic divalent C₁-C₃₀ hydrocarbon groups; and where
q is 1 or 2 or 3; and u is 1 or 2 or 3; and X is a hydrogen atom or a —C(═O)—R⁸ group where R⁸ is selected from hydrogen, C₁-C₂₀ alkyl groups, C₆-C₂₀ aryl groups, C₂-C₂₀ alkenyl groups and C₇-C₂₀ aralkyl groups.

2. The sulfur-crosslinkable rubber mixture as claimed in claim 1, wherein solution-polymerized styrene-butadiene rubber (SSBR) having a glass transition temperature T_{g} according to DSC of −35 to −85° C. is present in amounts of 50 to 100 phr, preferably 75 to 100 phr, particularly preferably 85 to 100 phr.

3. The sulfur-crosslinkable rubber mixture as claimed in claim 1, wherein the solution-polymerized styrene-butadiene rubber (SSBR) has a glass transition temperature T_{g} according to DSC of −40 to −65° C.

4. The sulfur-crosslinkable rubber mixture as claimed in claim 1, wherein q is 1 and/or u is 1 and/or X is an alkanoyl group.

5. The sulfur-crosslinkable rubber mixture as claimed in claim 1, wherein the silane A has the following structure according to formula A-II).
A-II) (EtO)₃Si-(CH₂)₃-S-(CH₂)₆-S-C(=O)-CH₃

6. The sulfur-crosslinkable rubber mixture as claimed in claim 1, wherein the silane B has the following structure according to formula B-II):

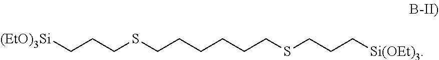

7. The sulfur-crosslinkable rubber mixture as claimed in claim 1, wherein the molar ratio of silanes A present to silanes B present is 20:80 to 90:10, preferably 55:45 to 70:30.

8. A vulcanizate obtained by sulfur vulcanization of the sulfur-crosslinkable rubber mixture as claimed in claim 1.

9. A vehicle tire, eh comprising the vulcanizate as claimed in claim 8.

10. The vehicle tire as claimed in claim 9, wherein the vulcanizate is provided in the tread.
